(19) United States
(12) Patent Application Publication
(10) Pub. No.: US 2026/0186447 A1
(43) Pub. Date: Jul. 2, 2026

(54) TIMEPIECE WITH ANALOG AND ELECTRONICS DISPLAYS

(71) Applicant: Shing Hin FAN, Tai Po, N.T., Hong Kong (HK)

(72) Inventor: Shing Hin FAN, Tai Po, N.T., Hong Kong (HK)

(21) Appl. No.: 18/862,632

(22) PCT Filed: Aug. 13, 2024
(86) PCT No.: PCT/CN2024/111606

§ 371 Date: Nov. 4, 2024

(30) Foreign Application Priority Data
Aug. 18, 2023 (HK) 32023077808.8

(51) Int. Cl. G04B 19/06; G04G 9/00

(52) U.S. Cl. CPC G04B 19/065; G04G 9/00

(57) ABSTRACT

Disclosed is an analog electronic timepiece having a case with a case interior and a plurality of hands driven to rotate about an axis to trace rotary paths, whereby rotation of the hands displays a time. A shutter overlies at least part of the rotary paths and is moveable between open positions in which the shutter reveals the at least part of the rotary paths and a closed position in which the shutter hides the at least part of the rotary paths. A drive mechanism in the case interior drives the shutter between the closed position and the open positions. An electro-optical display is operatively coupled to a control circuit, where the electro-optical display overlies the shutter and is operable by the control circuit between a transparent state in which the electro-optical display is transparent and a display state in which the electro-optical display shows an image.

### TECHNICAL FIELD

The present invention relates to a timepiece and, in particular, to a timepiece with both an analog display and an electronic display.

### BACKGROUND OF THE INVENTION

In the prior art, solutions are known for sequentially hiding and revealing a horological complication, for example, as for the purposes of attracting the user's focus and providing a pleasant effect.

EP0869409A2 discloses a watch with superimposed dials, with a diaphragm, placed between a lower graduated dial and an upper graduated dial. The diaphragm is composed of a plurality of thin mobile plates which can be partially superimposed on one another and is mobile between an open position to reveal the lower dial and a closed position to hide the lower dial. The upper dial is intended for the functions of basic indications such as the hour and minutes and the lower dial is intended for accessory functions.

U.S. Pat. No. 9,703,268B2 discloses a watch that includes a dial, an indicator and an electronic lens that covers the dial. The electronic lens can serve as an electronic display with opacity that is controllable and which allows images to be displayed on its surface.

U.S. Pat. No. 9,915,924B2 discloses a timepiece comprising a dial having at least one window for showing a display or internal mechanism of the timepiece, and a closure device for closing the window.

To obtain a pleasant effect, and to avoid high energy demands, movement of masking elements should be performed with low levels of acceleration and deceleration, and extended movement times. However, these limitations mean that functionality can be compromised if an element is occluded for a significant length of time, so there is a need for a more optimum solution. It is an object of the present invention to address this need or, more generally, to provide an improved timepiece.

### DISCLOSURE OF THE INVENTION

According to one aspect of the present invention there is provided an analog electronic timepiece comprising:
a case with a case interior;
a plurality of hands driven to rotate about an axis to trace rotary paths, whereby rotation of the hands displays a time;
a shutter that overlies at least part of the rotary paths and is moveable between open positions in which the shutter reveals the at least part of the rotary paths and a closed position in which the shutter hides the at least part of the rotary paths;
drive means in the case interior for driving the shutter between the closed position and the open positions;
a control circuit, and
an electro-optical display operatively coupled to the control circuit, wherein the electro-optical display overlies the shutter and is operable by the control circuit between a transparent state in which the electro-optical display is transparent and a display state in which the electro-optical display shows an image.

Preferably, the image comprises pointers that rotate about the axis, and the timepiece further includes synchronizing means by which the control circuit synchronizes rotation of the pointers with rotation of the hands, and operates the electro-optical display in the display state to show the pointers when the shutter is in the closed position, and in the transparent state when the shutter is in the open positions.

Preferably, the synchronizing means comprises a rotary encoder for sensing a rotation corresponding to the rotation of the hands and sending a synchronizing signal to the control circuit. Alternatively, the synchronizing means may comprise a clock sub-circuit in the control circuit with a user interface for setting a time on the clock sub-circuit, thus allowing the time on the clock sub-circuit to be synchronized with the time indicated by the hands of the analog display.

Preferably, the shutter comprises a first leaf and a second leaf mounted for movement relative to one another, each leaf including a respective array of apertures, wherein the drive means drives movement of at least one of the leaves.

Preferably, the first leaf is fixed and the second leaf is rotated relative to the first leaf about the axis by the drive means.

Preferably, the respective apertures of each leaf are sized and positioned alike so as to be in registration with one another, or to overlap one another, in the open positions, and where there is no overlap between the apertures in the closed position.

Preferably, the drive means comprises a stepper motor with a rotary shaft, the stepper motor operatively coupled to the control circuit, and the drive means further comprises an arm fixed at one end to the rotary shaft with an opposing end received in an opening in the second leaf, wherein the control circuit controls the stepper motor to oscillate the rotary shaft, and thereby oscillate the second leaf.

Preferably, the opening is located at the periphery of the second leaf.

Preferably, the hands are driven by a mechanical movement in the case interior, in the open positions the shutter reveals at least part of the mechanical movement and in the closed position the shutter hides the at least part of the mechanical movement.

Alternatively, the hands are driven by another type of movement, such as a quartz movement. The timepiece may further include a dial having angularly spaced time indicia, where in the open positions the shutter may reveal at least part of the dial and in the closed position the shutter may hide the at least part of the dial. In this case, the movement may be constantly and at least partially hidden under the dial.

Preferably, the first and second leaves are annular and coaxial, with the respective arrays of apertures formed in respective crescent-shaped portions of the leaves.

Preferably, the timepiece comprises a battery for supplying power to the drive means and the electro-optical display, and wherein the control circuit includes a charge level sensor for sensing a level of charge in the battery, wherein when the charge level falls to a minimum, the control circuit switches off the electro-optical display and operates the drive means to place the shutter in one of the open positions.

By showing an image on the electro-optical display, functionality is not compromised if an element is occluded for a significant length of time by the shutter, so it remains possible to avoid high energy demands by operating the shutter with low levels of acceleration and deceleration, and extended movement time.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 is a perspective view of an embodiment of the timepiece of the present invention;

FIG. 2 is a top view of the embodiment of the timepiece in FIG. 1;

FIG. 3 is an exploded view of the embodiment of the timepiece of the present invention;

FIG. 4 is a diagram showing an embodiment of the timepiece of the present invention, with its shutter in an open position;

FIG. 5 is a diagram showing an embodiment of the timepiece of the present invention, with its shutter in the closed position and electro-optical display displaying an image including a pointer;

FIG. 6 shows shutters of some embodiments of the timepiece of the present invention, with different apertures;

FIG. 7 is an embodiment of the timepiece of the present invention, showing how a stepper motor engages with the shutter.

### DESCRIPTION OF THE PREFERRED EMBODIMENTS

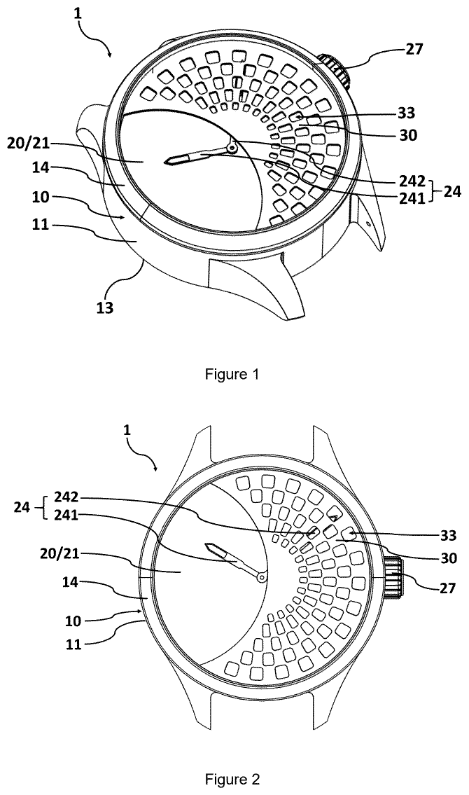

Referring to FIGS. 1 to 3, the timepiece 1 is an analog electronic timepiece, and has a case 10 with a case interior used for accommodating internal components of the timepiece 1. The case 10 has a substantially cylindrical shape and may include a side enclosure 11, a cover 12 and a base 13. The cover 12 is made of transparent material, such as glass or plastic, and is arranged at the top side of the side enclosure 11. The base 13 is arranged at the bottom side of the side enclosure 11, and may be detachably coupled or formed integrally with the side enclosure 11. A bezel 14 secures the cover 12 to the enclosure 11.

The timepiece 1 has a mechanical movement 20, which is arranged in the case interior. The timepiece 1 has a plurality of hands 24 driven to rotate about an axis to trace rotary paths, whereby rotation of the hands 24 displays a time. The mechanical movement 20 has a plurality of rotary outputs coaxial with one another. The hands 24 are fixed to respective ones of the rotary outputs to trace rotary paths, and overlie the mechanical movement 20. The hands 24 include an hour hand 241 and a minute hand 242, and may be in addition a second hand (not shown). A rotatable stem 26 radially extends from the mechanical movement 20, through the case 10, and is operable by a crown 27 coaxially arranged at the free end of the stem 26, for the user to adjust positions of the hands 24. Two pairs of flanges may be provided on the case 10, i.e. the side enclosure 11, opposite to each other across the side enclosure 11, with mounting holes, for installation of attachment means such as a strap or band. In other embodiments, other type of movements may be used, such as a quartz movement. In such cases, the timepiece may be a quartz or electronic timepiece showing an analog time with rotary outputs and hands driven by electric power.

The timepiece 1 has a shutter 30, which overlies at least part of the rotary paths and is moveable between open positions in which the shutter 30 reveals the at least part of the rotary paths and a closed position in which the shutter 30 hides the at least part of the rotary paths. A drive means 40 is provided and located in the case interior for driving the shutter 30 to move between the closed position and the open positions, and optionally among the different open positions. The timepiece 10 has an electro-optical display 50 which overlies the shutter 30 and is operable between a transparent state and a display state. The electro-optical display 50 is an electronic display such as an OLED display, a micro LED display or other types of transparent electronic display. In the transparent state, the electro-optical display 50 is transparent, and may not display images, allowing the user to view the hands 24 (and optionally a dial 21 having angularly spaced time indicia) below the electro-optical display 50. In the display state, the electro-optical display 50 shows an image, which may include one or more pointers that rotate about the axis (of rotation of the hands). The image is viewable by the user or viewer from the top or from obliquely top. The image may be non-transparent or semi-transparent. The electro-optical display 50 are operated in the display state by a control circuit 60, when the shutter 30 is in the closed position, and in the transparent state when the shutter 30 is in the open positions. In other terms, the display state of the electro-optical display 50 may occur at and/or continue for approximately same (amount of) time as the closed position of the shutter 30. In other examples, the electro-optical display 50 may be operated in the display state slightly earlier (e.g. 0.5-1 second(s) earlier) than that the shutter 30 reaches the closed position. In addition, the electro-optical display 50 may stay in the display state for a period of time (e.g. for 0.5-1 second(s)) after the shutter 30 moves from the closed position. Such cooperative and synchronized nature between the shutter 30 and the electro-optical display 50 brings about integrated display of time. The hands 24 in physical form and the image cooperatively indicate a single time in a fusion and synchronized manner, instead of independently indicating their own time information.

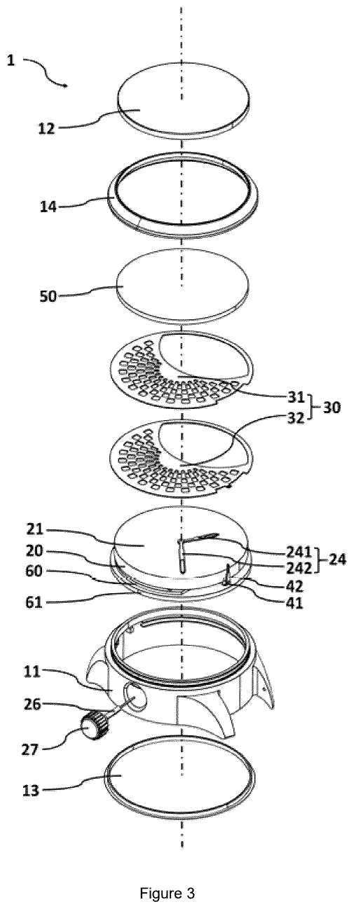

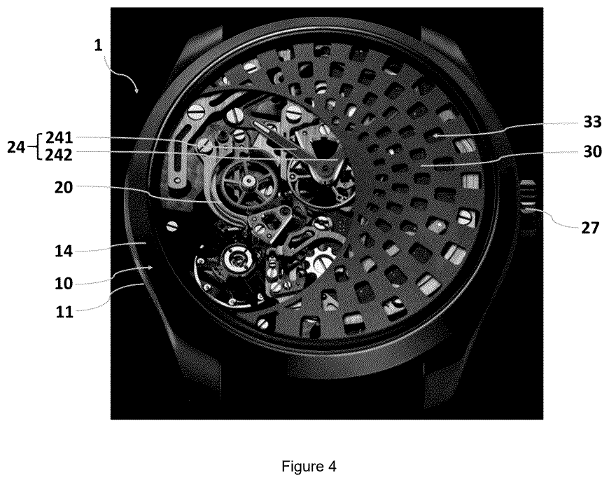

The control circuit 60 is located in the case interior, and may be located below the mechanical movement 20 as shown in FIG. 3. Alternatively, according to other embodiments of the timepiece 1, the control circuit 60 may be located in other locations. For instance, the control circuit 60 may be located at a lateral side of the mechanical movement 20. In some embodiments of the present invention, the control circuit 60 may also be coupled to the drive means 40, in addition to the electro-optical display 50. In some embodiments of the present invention, the control circuit 60 may include a first circuit coupled the electro-optical display 50 and a second circuit coupled to the drive means 40. The first circuit and the second circuit may be integrated or separated. The control circuit 60 may be supported by a circuit substrate 61.

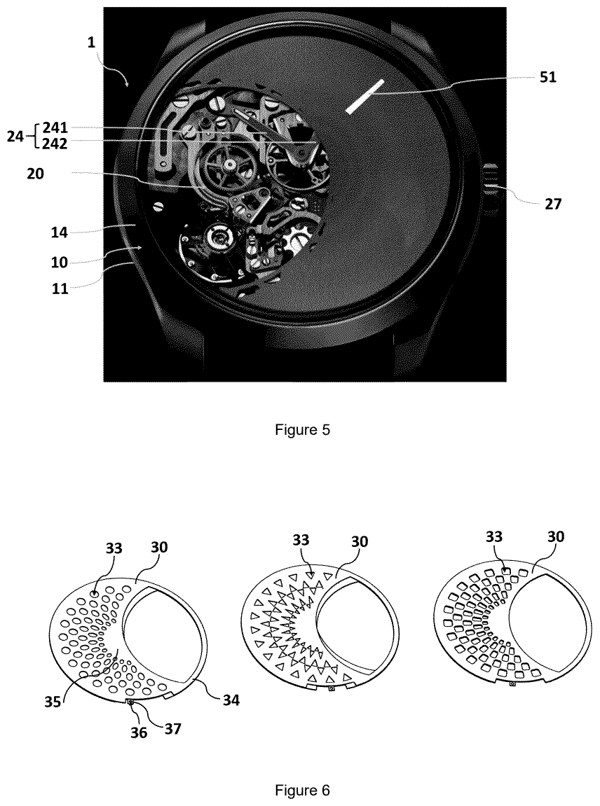

The timepiece 1 further includes synchronizing means by which the control circuit 60 (as the controller) may synchronize rotation of the pointers with rotation of the hands 24. FIG. 5 shows an hour hand 241 viewable as a whole and a minute hand 242 with its most part hidden under the shutter 30. The electro-optical display 50 displays a pointer, i.e. known as a minute pointer, which rotates about the axis, in the same direction, i.e. clockwise direction, as the minute hand 242. The synchronizing means synchronizes rotation of the minute pointer with rotation the minute hand 242, such that the minute pointer is moved and maintained to be on the right top of the hidden minute hand 242 in the course of their rotations. The axis about which the pointer rotates is the same as the axis about which the hands 24 rotate.

The synchronizing means may include a rotary encoder sensing a rotation corresponding to the rotation of the hands 24 and sending a synchronizing signal to the control circuit 60. For instance, the rotary encoder may sense rotational movements or the angular positions of the rotary outputs and/or the respective hands 24 fixed to the rotary outputs, and then convert the movements and/or positions into electronic signals to the control circuit 60 for further process and use for synchronization. Specifically, with the use of the electronic signals, the control circuit 60 can determine the positions of the pointer to be displayed on the electro-optical display 50, and synchronize the rotation of the pointer with its respective hand. Alternatively, or in addition, the synchronizing means may include a clock sub-circuit in the control circuit 60. The clock sub-circuit may keep the time, which can be set by the user. In this way, the control circuit 60 synchronizes the rotation of a pointer by keeping the rotation of the pointer at a right pace according to the clock sub-circuit. The timepiece may further provide an interface for setting the time of the clock sub-circuit.

The shutter 30 may include a first leaf 31 and a second leaf 32, which may be both in form of circular shape, mounted for movement relative to one another. The two leaves 31, 32 may be arranged to be coaxial (i.e. share a common axis). Each leaf may include a respective array of apertures 33. The drive means drives movement of at least one of the leaves 31, 32. The shutter may be configured to cover at least part of the rotary paths of the hands 24 and/or at least part of the mechanical movement 20. Each of the first and second leaves 31, 32 may have an annular structure 34. Each of the first and second leaves 31, 32 may further have a crescent-shaped portion 35. The crescent-shaped portion 35 is located at the inner side of the annular structure 34 of each of the leaves 31, 32. The crescent-shaped portion 35 has a longer curved side and a shorter curved side with a greater curvature compared with the longer curved side. The longer curved side and the shorter curved side jointly define the profile of the crescent-shaped portion 35. The longer curved side of the crescent-shaped portion 35 adjoins the inner side of the annular structure 34. The respective arrays of apertures 33 are formed in respective crescent-shaped portions 35 of the leaves 31, 32. A cavity is formed in the shutter 30 (i.e. each of the first and second leaves 31, 32) and defined by the shorter curved side of the crescent-shaped portion 35 and the part of the inner side of the annular structure 34 that does not adjoin the crescent-shaped portion 35. The hands 24 which are under the cavity is viewable, regardless of the positions of the shutter 30 and the states of the electro-optical display 50.

In an embodiment of the present invention, the first leaf 31 is fixed and the second leaf 32 is rotated relative to the first leaf 31 about the axis by the drive means 40. The first leaf 31 is the upper leaf and is fixed. The second leaf 32 is the lower leaf and is rotatable relative to the first leaf 31 about the axis. Optionally, the axis about which the shutter 30 (i.e. the second leaf 32) rotates may be the same as the axis about which the hands 24 rotate (thus the axis about which the one or more pointers of the image rotate). The two leaves 31, 32 are arranged in parallel to each other. In some examples, the two leaves 31, 32 may be arranged to be adjacent to but spaced apart from each other. In these cases, the distance between the two leaves 31, 32 may be set to be considerably small or even negligible. In some other examples, the two leaves 31, 32 may be arranged to adjoin each other. In these cases, friction reduction may be optimized by e.g. using suitable computerized numerical control (CNC) machining techniques, such as “Zero tolerance machining” by wire electrical discharge machining (wire EDM), to produce the two leaves 31,32, in order to make smooth movement of the shutter 30 feasible.

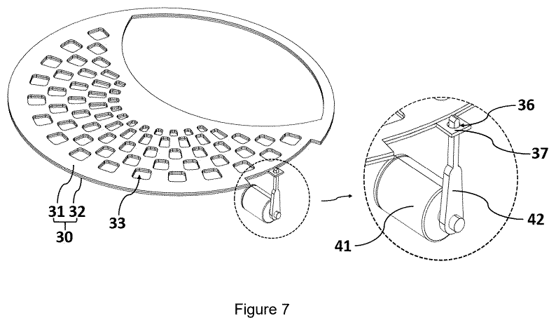

The respective apertures 33 of each leaf are sized and positioned alike so as to be in registration with one another, or to overlap one another, in the open positions, and where there is no overlap between the apertures 33 in the closed position. The apertures 33 of each leaf may have same angular extent. In particular, the apertures 33 on the first leaf 31 have substantially same angular extent as the corresponding apertures 33 on the second leaf 32. In the open positions, apertures 33 on the first leaf 31 are in registration with or overlaps corresponding apertures 33 on the second leaf 32. In the closed positions, apertures 33 on the first leaf 31 do not overlap the corresponding apertures 33 on the second leaf 32. To transit from the open positions to the closed position or among the open positions, the second leaf 32 rotates about the axis anticlockwise (as viewed from the top). The apertures 33 may be in form of different shapes and sizes. For instance, as shown in FIG. 7, the apertures 33 may be in form of circles/ellipses, triangles and/or rectangles/squares, or a combination thereof, with different sizes. The apertures 33 may be grouped into concentric circular arrays. The apertures 33 from different circular arrays are different. For instance, the sizes of apertures increase along the radial direction from the centre to periphery of the shutter 30. It is preferable that the apertures 33 of the first leaf 31 and of the second leaf 32 attain the non-overlapping states with one another simultaneously once the shutter 30 reaches the closed position from one of the open positions, to achieve simultaneous disappearance of the apertures 33 in the visual sense.

The drive means 40 may include an electric actuator, which may be operatively coupled to the control circuit 60. The electric actuator operates to actuate movement of the shutter 30, i.e. relative movement of the first leaf 31 and the second leaf 32. For example, as shown in FIG. 7, the drive means 40 (or the electric actuator) may include a stepper motor 41 with a rotary shaft. Alternatively, the drive means 40 may include a linear actuator to actuate movement of the shutter 30. There may be one or more motion transmission components for transmitting force from the drive means 40 to the shutter 30. For example, the drive means 40 may further include an arm 42. The arm 42 may be fixed to the rotary shaft at one end and engaged with the shutter 30 at the other end. In particular, an opening 36 is provided in the second leaf 32. The other end (the opposing end) of the arm 42 may be received in the opening 36, so that the shutter 30 (i.e. the second leaf 32) can be actuated by the drive means. The control circuit 60 controls the stepper motor 41 to oscillate the rotary shaft, and thereby oscillate the second leaf 32. The opening 36 may be located at the periphery of the second leaf 32, such that force from the drive means acts at the periphery of the second leaf 32 along the circumferential direction or tangential direction or a direction between the circumferential direction and the tangential direction, to move the shutter 30 between the open positions and the closed position. At the periphery of the second leaf 32 there may be provided a tab 37, on which the opening 36 is located. A recess, which is elongate along the circumferential direction of the shutter 30, may be formed at the periphery of the first leaf 31, to offer space for movement of the motion transmission parts such as the arm 42. Optionally in addition, another recess may be formed at the periphery of the second leaf 32, so that the recess of the first leaf 31 at least partially overlaps with the recess of the second leaf 32 in the open positions or in the closed position. The tab 37 is located in the recess of the second leaf 32.

The second leaf 32 may oscillate between the closed position and the open position where apertures 33 on the second leaf 32 are in registration with corresponding apertures 33 on the first leaf 31 (i.e. maximum overlapping extent between the apertures 33). For instance, the second leaf 32 takes about 1.5 seconds to about 3 seconds for moving from the open position with maximum overlapping extent to the closed position (e.g. by rotating anticlockwise), with modest acceleration and deceleration during the movement. The second leaf 32 takes about the same time for moving back, i.e. from the closed position to the open position (e.g. by rotating clockwise), with substantially the same acceleration/deceleration profile compared with the anticlockwise rotation. For instance, the angular position change for moving from the closed position to the open position and vice versa is from about 3° to about 12°, or from about 7° to about 8°. The present invention allows lower levels of acceleration and deceleration, and extended movement time of the shutter 30, without compromising the functionality of the timepiece 1.

Alternatively the drive means 40 may include a power take-off driven by the mechanical movement 20, instead of a separated electric actuator. In this case, the drive means 40 may also include one or more motion transmission components such as an arm 42 with identical feature and function as mentioned above.

The shutter 30 may overlie one part of each of at least one of the hands 24 and does not overlie the other part of each of the at least one hand. In the open positions the shutter 30 may reveal at least part of the mechanical movement 20 and in the closed position the shutter 30 may hide the at least part of the mechanical movement 20. Alternatively, the timepiece may further include a dial 21 having angularly spaced time indicia, where in the open positions the shutter 30 may reveal at least part of the dial 21 and in the closed position the shutter 30 may hide the at least part of the dial 21.

Referring back to FIGS. 5, the shutter 30 is in one of the open positions and the electro-optical display 50 is in its transparent state (thus being substantially invisible in the FIG. 5). The timepiece 1 includes the shutter 30 with the first and second leaves 31, 32, each having a crescent-shaped portion 35, on which apertures 33 are provided.

The shutter 30 in the open position reveals part of the minute hand 242 beneath it through its apertures 33. The hour hand 241 is currently beside the shutter 30, i.e. not under its crescent-shaped portion 35. As the hands 24 rotate (clockwise), they enter and leave the shadow of the shutter 30 (the crescent-shaped portion 35) in the course of their rotation.

FIG. 6 shows the same embodiment as FIG. 5, except that the shutter 30 is in its closed position and the electro-optical display 50 is in its display state. The shutter 30 in its closed position hides part of the rotary path traced by the minute hand 242, as the shutter 30 includes crescent-shaped portions 35 that cover the part of the rotary path. At the moment shown in FIG. 6, as the minute hand 242 is located under the shutter 30, the shutter 30 hides the minute hand 242 (i.e. hiding the tip portion and middle portion of the minute hand 242, not including the root portion proximate to the rotary outputs), so the minute hand (i.e. its tip portion and middle portion) becomes invisible when viewed from the top. The electro-optical display 50 displays an image including a pointer that rotates about the axis (same axis as the minute hand 242's rotation). The pointer's rotation is synchronized with the rotation of the minute hand 242 beneath it. In this embodiment, the shutter 30 overlies one part of the minute hand 242 (i.e. the top portion and middle portion of the minute hand 242), and does not overlies the other part (i.e. the root portion of the minute hand 242). This offers to the viewer a unique effect, in which the image including the pointer of the minute hand 242 and the other part of the minute hand 242 are shown together in a fusion and synchronized way. This may also apply to the hour hand 241 and optionally the second hand. In some other embodiments, alternatively the shutter 30 may cover substantially the whole hand when the hand rotates to a location under the shutter 30.

The shape of the electro-optical display 50 in this example is cylindrical. In other terms, it has a substantially circular (cross-sectional) shape when viewed from the top, which corresponds to the shapes of shutter 30 and mechanical movement 20, which are both substantially circular. In other examples, electro-optical display 50 may be in form of other shapes, such as crescent shape corresponding to the crescent-shaped portion 35 of the shutter 30. In this example or the other examples, optical contrast-enhancing material may be disposed above or on the shutter 30 to increase the contrast of the image shown by the electro-optical display 50 with respect to the background around the image, so that the image becomes more visible to the viewer.

The timepiece 1 includes a battery, for supplying power to at least the electro-optical display 50. In addition, the power source may also supply power to the drive means 40 and/or the control circuit 60. The control circuit 60 includes a charge level sensor for sensing a level of charge in the battery. When the charge level falls to a minimum, the control circuit switches off the electro-optical display 50 and operates the drive means 40 to place the shutter 30 in one of the open positions. This serves as a mechanism to allow the battery to allocate a (last) amount of power to drive and then keep the shutter 30 to the one of the open positions, so that the hands 24 under the shutter 30 remain visible when/after the electro-optical display 50 runs out of power. There may be exist in the prior art a timepiece with a display disposed on the top, and the display requires electric power (from a battery) to maintain its operation. There is a common problem in this type of timepiece, which is power supply from a battery is limited and when the battery and thus the display are out of power, not only is the display not able to show images any more, it may also block the viewer from viewing the analog display (i.e. hands) below the display. Therefore, the above feature of the present invention serves to solve such bottleneck in the prior art, by cooperative operation of the shutter 30 and the electro-optical display 50 corresponding to the charge level of the battery.

Aspects of the present invention have been described by way of example only and it should be appreciated that modifications and additions may be made thereto without departing from the scope thereof.

1. An analog electronic timepiece comprising:
a case with a case interior;
a plurality of hands driven to rotate about an axis to trace rotary paths, whereby rotation of the hands displays a time;
a shutter that overlies at least part of the rotary paths and is moveable between open positions in which the shutter reveals the at least part of the rotary paths and a closed position in which the shutter hides the at least part of the rotary paths;
a drive means in the case interior for driving the shutter between the closed position and the open positions;
a control circuit; and
an electro-optical display operatively coupled to the control circuit, wherein the electro-optical display overlies the shutter and is operable by the control circuit between a transparent state in which the electro-optical display is transparent and a display state in which the electro-optical display shows an image.

2. The timepiece of claim 1, wherein the electro-optical display shows an image comprising pointers that rotate about the axis, and the timepiece further comprises a synchronizing means by which the control circuit synchronizes rotation of the pointers with rotation of the hands, and operates the electro-optical display in the display state to show the pointers when the shutter is in the closed position, and in the transparent state when the shutter is in the open positions.

3. The timepiece of claim 2, wherein the synchronizing means comprises a rotary encoder for sensing a rotation corresponding to the rotation of the hands and sending a synchronizing signal to the control circuit.

4. The timepiece of claim 1, wherein the shutter comprises a first leaf and a second leaf mounted for movement relative to one another, each leaf including a respective array of apertures, wherein the drive means drives movement of at least one of the leaves.

5. The timepiece of claim 4, wherein the first leaf is fixed and the second leaf is rotated relative to the first leaf about the axis by the drive means.

6. The timepiece of claim 4, wherein the respective apertures of each leaf are sized and positioned alike so as to be in registration with one another, or to overlap one another, in the open positions, and where there is no overlap between the apertures in the closed position.

7. The timepiece of claim 6, wherein the drive means comprises a stepper motor with a rotary shaft, the stepper motor operatively coupled to the control circuit, and the drive means further comprises an arm fixed at one end to the rotary shaft with an opposing end received in an opening in the second leaf, wherein the control circuit controls the stepper motor to oscillate the rotary shaft, and thereby oscillate the second leaf.

8. The timepiece of claim 7, wherein the opening is located at the periphery of the second leaf.

9. The timepiece of claim 1, wherein the hands are driven by a mechanical movement in the case interior, in the open positions the shutter reveals at least part of the mechanical movement and in the closed position the shutter hides the at least part of the mechanical movement.

10. The timepiece of claim 4, wherein the first and second leaves are annular and coaxial, with the respective arrays of apertures formed in respective crescent-shaped portions of the leaves.

11. The timepiece of claim 1, further comprising a battery for supplying power to the drive means and the electro-optical display, and wherein the control circuit includes a charge level sensor for sensing a level of charge in the battery, wherein when the charge level falls to a minimum, the control circuit switches off the electro-optical display and operates the drive means to place the shutter in one of the open positions.
